(19) United States
(12) Patent Application Publication
(10) Pub. No.: US 2002/0143801 A1
(43) Pub. Date: Oct. 3, 2002

(54) A METHOD OF DOWNLOADING NEW VERSION SOFTWARE INTO A TRANSMISSION SYSTEM WHICH OPERATES ACCORDING TO THE SOFTWARE AND A TRANSMISSION SYSTEM HAVING FUNCTION FOR DOWNLOADING THE NEW VERSION SOFTWARE

(76) Inventors: HISAYA OKAMOTO, YOKOHAMA-SHI (JP); AKIHIRO SUGAYA, KAWASAKI-SHI (JP)

Correspondence Address: KATTEN MUCHIN ZAVIS ROSENMAN, 575 MADISON AVENUE, NEW YORK, NY, 10022-2585, US

(21) Appl. No.: 09/334,767

(22) Filed: Jun. 16, 1999

(30) Foreign Application Priority Data
Oct. 1, 1998 (JP) 10-279623

(51) Int. Cl. G06F 12/00

(52) U.S. Cl. 707/203

(57) ABSTRACT

When new software is run in a transmission system, an interchangeable version that indicates software versions capable of residing in a network is specified in a judgment table. Software versions existing at remote transmission systems interconnected over the network are compared with the interchangeable version. If the versions existent at the remote transmission systems are contained in the interchangeable version, a command Start of Downloading is reported to the remote transmission systems. The software of a new version is then downloaded. It is thus impossible to download software that is not interchangeable. When downloading is completed, the end of downloading is reported to the remote transmission systems. A communication failure stemming from downloading is thus prevented.

### BACKGROUND OF THE INVENTION

1. Field of the Invention

The present invention relates to a method of downloading software of a new version into a control unit in a transmission system connected on a network, and a transmission system for controlling downloading of software of a new version.

Transmission systems, for example, an exchange, are widely adopted in the field of communications. The exchange has various kinds of lines (for example, a subscriber line and a multiplexed relay line) connected thereto, and switches the lines. Such a transmission system operates according to software. Since hardware and software realizing a transmission system are improved frequently, the necessity of updating software of the transmission system arises frequently. However, various types of transmission systems have been put to use. Even if a new software version is provided, the new software version is not always compatible with every transmission system. If an incompatible software version is downloaded into a transmission system, a failure would occur in the transmission system.

2. Description of the Related Art

FIG. 1 shows a conventional method of judging if two software versions are compatible with a transmission system. This conventional method has been described in Japanese Unexamined Patent Publication (Kokai) No. 61-115131.

In FIG. 1, there are shown software A 80, and software B 81 having a relationship of a main routine program and subroutine program to the software A. Also shown are AND gates 82 and 83 and comparators 84 and 85. A gate 86 calculates the AND of signals sent from the comparators 84 and 85, and an output unit 87 produces a signal indicating if downloading is enabled.

The software A and software B include level tables La and Lb respectively and test tables Tab and Tba respectively. FIG. 2 shows examples of tables. In the level tables La and Lb, version information is indicated by setting 1 at a bit position in the table. In the test table Tab, a version of software B with which the current software A matches is indicated by setting 1 at a bit position in a bit stream of which number corresponds to the version. In the test table Tba, a version of software A with which the current software B matches is indicated by setting 1 at a bit position in a bit stream of which number corresponds to the version.

In the example of FIG. 2, the bit streams of the level tables La and Lb indicate that software A is of version 3 and software B is of version 4. Moreover, the test table Tab indicates that software A matches with versions 3 to 7 of software B but does not match with versions 0 to 2 thereof. The test table Tba indicates that software B matches with versions 2 to 7 of software A but does not match with versions 0 and 1 thereof.

Actions will be described. The gate 82 calculates the AND of data retrieved from the test table Tab and the level table Lb (AND of data at the same bit positions in the bit streams), and supplies a result to the comparator 84. The gate 83 calculates the AND of data retrieved from the test table Tba and the level table La, and supplies a result to the comparator 85. In the example of tables shown in FIG. 2, data 00001000 (the leftmost bit is the most significant bit) is output from the gate 82, and data 00010000 is output from the gate 83.

The outputs of the gates 82 and 83 are compared with 0 by the comparators 84 and 85 respectively. If each output agrees with 0, 0 is output. If each output disagrees with 0, 1 is output. The outputs of the comparators 84 and 85 are ANDed by the gate 86. If it is detected that software matches each other, an output of 1 is supplied to the output unit 87. In the example shown in FIG. 2, if the comparators 84 and 85 produce 1, 1s are ANDed by the gate 86. In this case, 1 is produced. This means that software A and software B are not inconsistent with each other in terms of control given thereby (software A and software B match with each other).

FIG. 3 shows a conventional method of managing versions on a network. FIG. 4 is a flowchart describing actions to be performed in a terminal-oriented mode of the method shown in FIG. 3. FIG. 5 is a flowchart describing actions to be performed in a server-oriented mode. The conventional method has been described in Japanese Unexamined Patent Publication (Kokai) No. 2-268345.

In the example shown in FIG. 3, a network consists of node 1 to node 4 (transmission systems 1 to 4). A version management server 90 is provided for the network. The version management server 90 consists of a data base server 91 having a software management data base 910 and a file server 92 having a file service facility 920.

In this example, the version management server 90 inquires of the data base server 91 about the latest version. If necessary, the version management server 90 uses the facility of the file server 92 to download the latest version. For judging if downloading is enabled, there are two methods. One of the methods involves a terminal, and the other involves a server. The methods are described in FIG. 4 and FIG. 5.

In a terminal-oriented mode, as shown in FIG. 4, when a terminal is started up (step S11), the terminal acquires a current software version (step S12), and receives the latest software version from the version management server 90 (step S13). Thereafter, the two obtained versions are compared with each other (step S14). It is judged whether downloading is needed (step S15). If it is judged that downloading is needed, software of the latest version is downloaded from the version management server (step S16). If it is not judged that downloading is needed, processing is terminated.

Moreover, in the server-oriented mode, as described in FIG. 5, when a terminal accesses the server, a current software version existent in the terminal is acquired (step S21). A software version to be downloaded is received from the data base server 91 (step S22). The two obtained versions are compared with each other (step S23). It is then judged if downloading is needed (step S24). If downloading is needed, the facility of the file server is used to download software (step S25). If downloading is not needed, downloading is suspended.

In the first example, if it is judged that software of the latest version is compatible with one transmission system, the software may be downloaded into the transmission system. However, a trouble may occur when the transmission system is connected on a network and operated. Specifically, if the software of the latest version is not interchangeable with software versions employed on the network (not adaptable to the network), a failure may occur on the network due to the downloaded software.

In the second example, the network server is employed. In this case, versions employed in a network can be managed readily. However, if a server fails or the network is disconnected, nothing can be carried out. This poses a problem. Besides, fundamentally, a transmission system at each node communicates with another at another node without use of a network server. The transmission system can carry out downloading without the help of the network server. If each system downloads software, the network server cannot manage software versions any longer. This poses a problem.

### SUMMARY OF THE INVENTION

An object of the present invention is to provide a method of downloading software and a transmission system in which the downloading method is implemented. The method of downloading software prevents downloading of software, which is not interchangeable, into a transmission system, and avoids occurrence of a communication failure on a network due to illegal downloading.

The present invention attempts to accomplish the above object.

A transmission system in accordance with the present invention is connected on a network, and operated according to software. The transmission system of the present invention includes a judgment table, and specifies versions interchangeable with new software in the judgment table. The interchangeable versions are software versions that can reside in the network with the new software in the transmission system. A communication unit transmits a command requesting version information of current software existing in a transmission system to the remote transmission systems interconnected over the network. When version information of current software is received from each remote transmission system, a judgment unit judges if version information received from each remote transmission system is included in the interchangeable versions specified in the judgment table.

If the judgment unit judges that version information received from each transmission system is included in the interchangeable versions, a control unit starts downloading. Moreover, if the judgment unit judges that version information received from each transmission system is not included in the interchangeable versions, the control unit generates an alarm and suspends execution of downloading. Consequently, it is impossible to download software incompatible with each transmission system connected on the network. Eventually, a communication failure occurring on the network can be avoided.

Before starting downloading, the control unit issues a command indicating that a local transmission system starts downloading to remote transmission systems interconnected over the network. Thereafter, the control unit downloads software of a new version into the local transmission system. After downloading is completed, the control unit reports Downloading Completed to the remote transmission systems. The transmission systems interconnected over the network can be aware of the fact that downloading is carried out. Even if the network becomes unstable transiently during downloading, no failure will occur on the network.

According to the foregoing present invention, downloading source version information may be acquired and specified in the judgment table. The downloading source version information indicates software versions permitting software of a new version to be treated as an object of downloading. In this case, the judgment unit judges whether the version of software existent in the local transmission system is included in the downloading source version information.

If the judgment unit judges that the version of software existent in the local transmission system is included in the downloading source version information, the control unit issues a command to the remote transmission systems interconnected over the network. The command indicates that the local transmission system should start downloading. The control unit then downloads the software of a new version into the local transmission system. If the judgment unit judges that the version of software existent in the local transmission system is not included in the downloading source version information, the control unit generates an alarm to suspend execution of downloading.

According to this example, it can be prevented that software that is not interchangeable is downloaded into a transmission system. Consequently, a communication failure occurring on a network due to illegal downloading can be avoided.

### BRIEF DESCRIPTION OF THE DRAWINGS

The above object and features of the present invention will be more apparent from the following description of the preferred embodiment with reference to the accompanying drawings, wherein:

FIG. 1 shows a conventional method of judging the compatibility of two software versions with a transmission system;

FIG. 2 shows the contents of a table employed in the method shown in FIG. 1;

FIG. 3 shows a conventional method of managing versions on a network;

FIG. 4 is a flowchart describing actions to be performed in a terminal-oriented mode of the version managing method shown in FIG. 3;

FIG. 5 is a flowchart describing actions to be performed in a server-oriented mode of the version managing method shown in FIG. 3;

FIG. 6 shows the principles and configuration of a transmission system to which the present invention is adapted;

FIG. 7 shows the architecture of a network accommodating a transmission system in accordance with the present invention;

FIG. 8 shows circuitry in a transmission system to which the present invention is adapted;

FIG. 9 is a flowchart (part 1) describing downloading to be carried out in the transmission system shown in FIG. 8;

FIG. 10 is a flowchart (part 2) describing downloading to be carried out in the transmission system shown in FIG. 8;

FIG. 11A lists commands employed in the present invention, and FIG. 11B shows a format of a command;

FIG. 12 lists alarms or states relevant to downloading;

FIG. 13 lists the contents of a judgment table;

FIG. 14 shows the architecture of a network for an example of downloading control in accordance with the present invention;

FIG. 15 shows a judgment table of an example;

FIG. 16 shows the architecture of a network in which the first example of downloading control is implemented;

FIG. 17 describes a processing sequence of the first example;

FIG. 18A shows a judgment table of the first example, and FIG. 18B shows a version storage table;

FIG. 19 shows the architecture of a network in which the second example of downloading control is implemented;

FIG. 20 describes a processing sequence of the second example;

FIG. 21A shows a judgment table of the second example, and FIG. 21B shows a version storage table;

FIG. 22 shows the architecture of a network in which the third example of downloading is implemented;

FIG. 23 describes a processing sequence of the third example (part 1);

FIG. 24 describes a processing sequence of the third example (part 2); and

FIG. 25A shows a judgment table of the second example, and FIG. 25B shows a version judgment table.

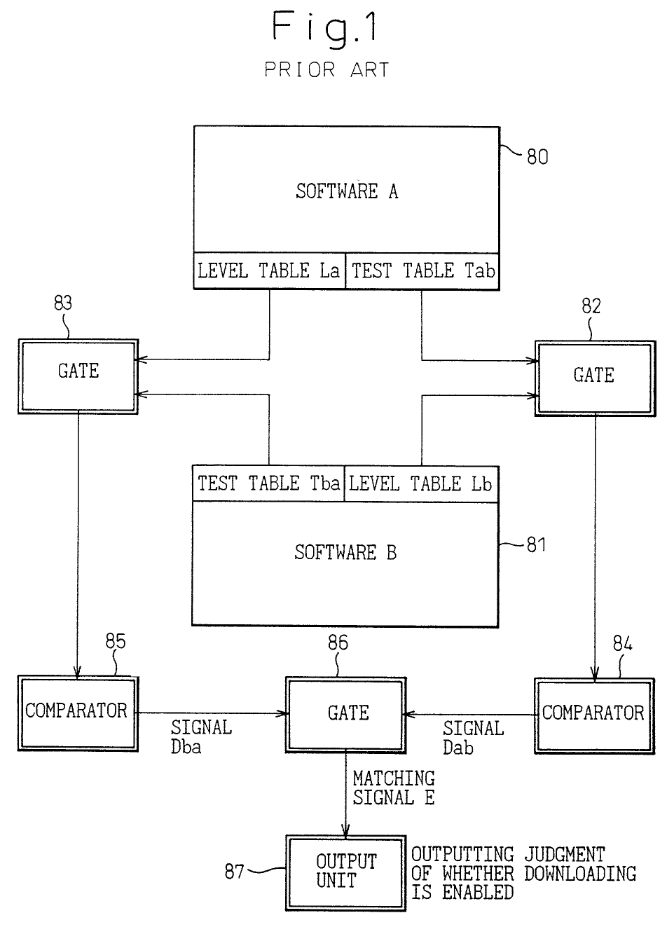

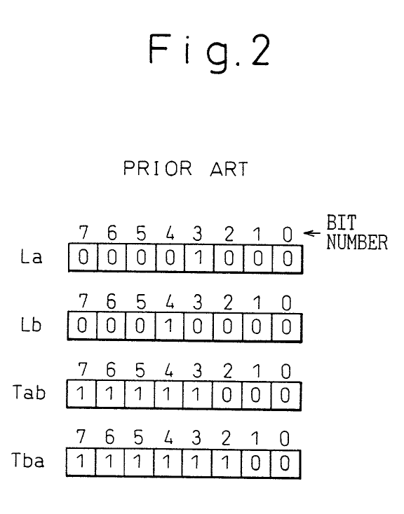

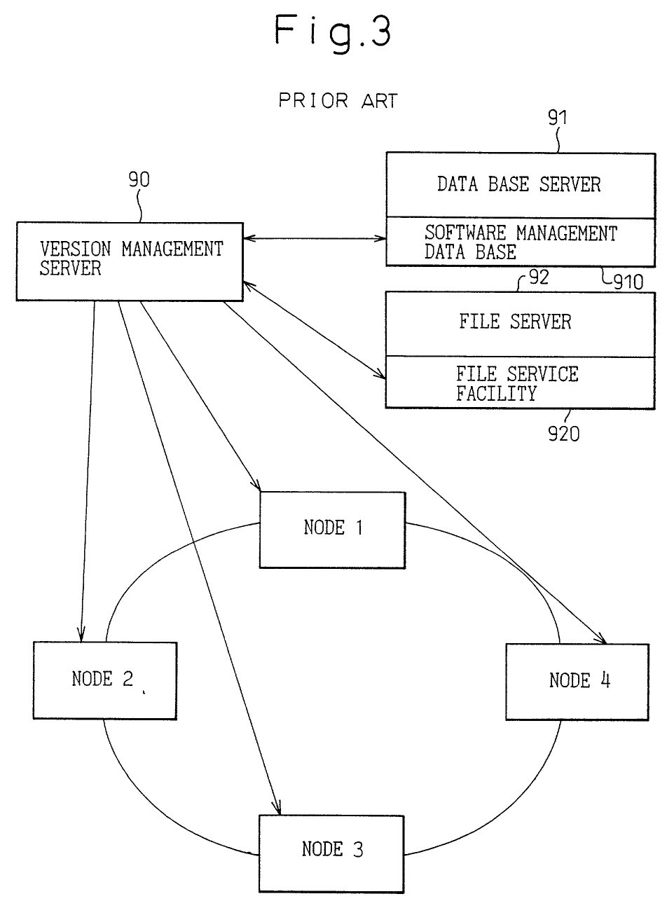

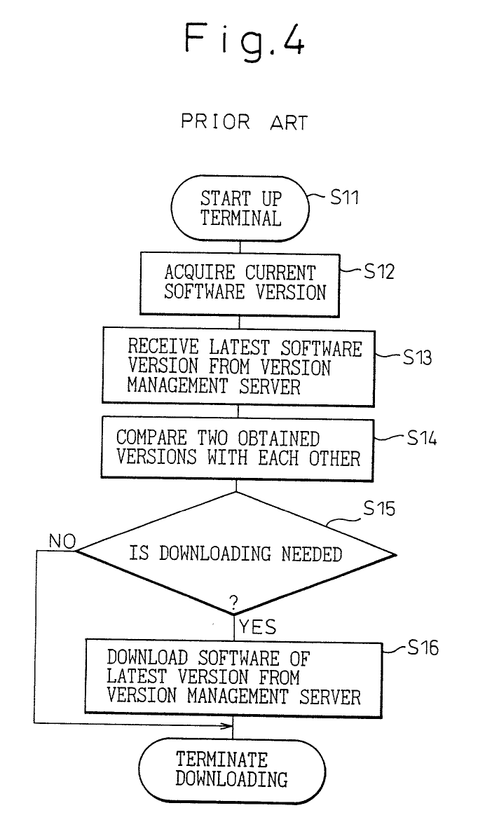

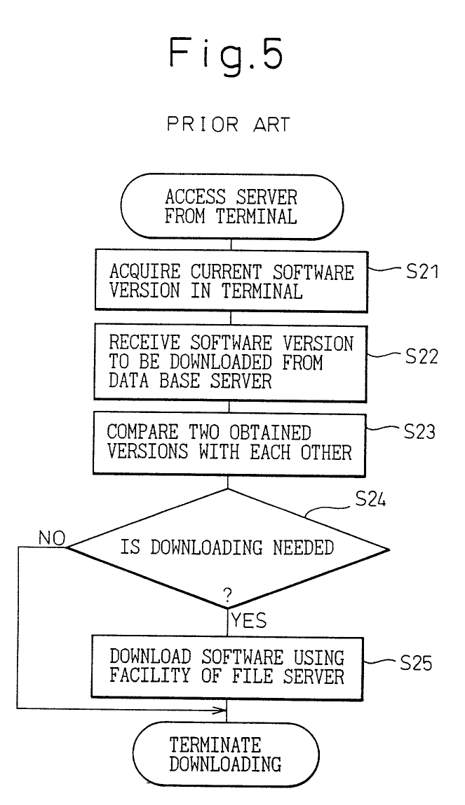

### DESCRIPTION OF THE PREFERRED EMBODIMENTS

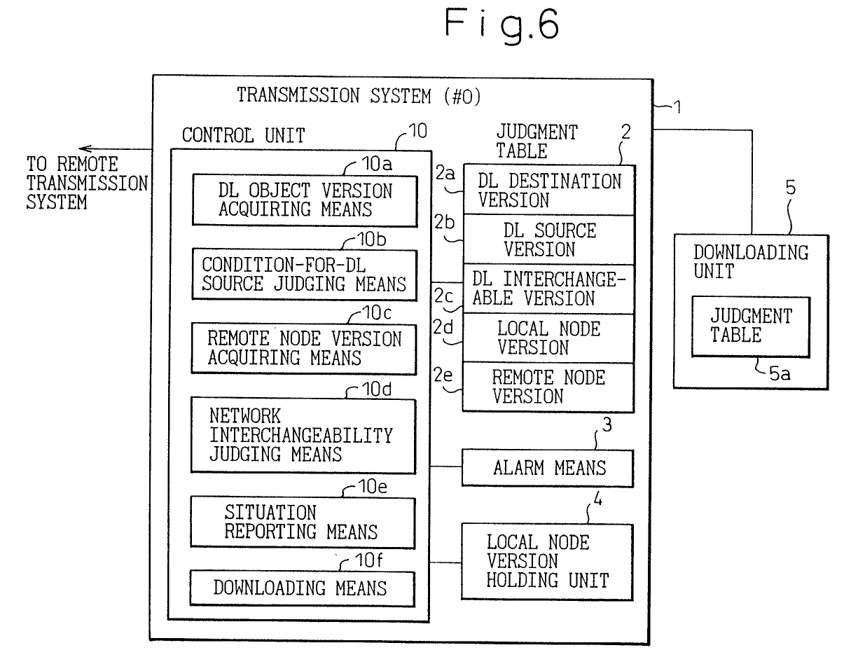

FIG. 6 shows the principles and configuration of a transmission system in accordance with the present invention. In the drawing, there is shown a transmission system 1 (node) having software to be downloaded. A network consists of a plurality of transmission systems 1 Nos. 0 to n. The transmission system 1 No. 0 is an object of downloading. The plurality of the other transmission systems 1 Nos. 1 to n are not illustrated. The transmission system 1 comprises a control unit 10, a judgment table 2, an alarm means 3, a local node version holding unit 4, a downloading unit 5. The control unit 10 includes a downloading (DL) object version acquiring means 10a, a condition-for-downloading (DL) source judging means 10b, a remote node version acquiring means 10c, a network interchangeability judging means 10d, a state reporting means 10e for reporting a downloading situation to each node, and a downloading means 10f for executing downloading. The judgment table 2 contains a downloading (DL) destination version 2a indicating a version to be downloaded, a downloading (DL) source version 2b, a downloading (DL) interchangeable version 2c, a local node version 2d, and a remote node version 2e. The downloading unit 5 (for example, a personal computer) has software to be downloaded and includes a judgment table 5a containing version information of software to be downloaded.

The features of the present invention will be described below. Namely, a downloading node (local node) or a node attempting to download a certain version requests the remote nodes accommodated by the network for their software versions. In response to the versions from the nodes, it is judged from the versions if any environment permits downloading into the local node. Only when an environment permits downloading, downloading is carried out. It is thus prevented that a failure occurs in the network. For carrying out downloading, a command reporting the start of downloading is issued to each node prior to downloading. When downloading is completed, a command reporting the end of downloading is issued to each node. A node engaged in downloading is thus identified, whereby occurrence of a failure is prevented.

Referring to FIG. 6, in the transmission system (No. 0) that is an object of downloading, the downloading unit 5 carries out downloading. At this time, the judgment table 5a is set as the judgment table 2 in the transmission system 1. A downloading destination version and downloading source version are specified as items 2a and 2b in the judgment table 2. Moreover, (a plurality of) versions usable on the network are specified as the downloading interchangeable version 2c in the judgment table 2. The control unit 10 drives the downloading object version acquiring means 10a. The transmission system 1 (No. 0) acquires the local node version from the local node version holding unit 4. It is then judged whether a version acquired by the condition-for-downloading source version judging means 10b is contained in the downloading source version 2b in the judgment table 2. If the condition is not met, the alarm means 3 is driven in order to indicate that downloading is disabled. If the condition is met, the version is specified in the local node version 2d in the judgment table 2.

Thereafter, the remote node version acquiring means 10c is driven. The remote transmission systems 1 (Nos. 1 to n not shown) are tested for version information. The versions existing in the remote transmission systems are thus acquired and specified in the remote node version 2d in the judgment table. Thereafter, the network interchangeability judging means 10d judges if the acquired versions existent at the remote nodes agree with interchangeable versions specified in the downloading interchangeable version 2c and meets the condition. If an acquired version does not meet the condition, the alarm means 3 is driven in order to indicate that downloading is disabled. If the condition is met, the state reporting means 10e reports the start of downloading to the remote nodes, and causes the downloading means 10f to execute downloading. When downloading is completed, the state reporting means 10e reports the end of downloading to the remote nodes.

As mentioned above, for downloading an upper-level version of software into a transmission system, it is judged if the upper-level version is a downloading source at the level to which a current software version in the local node can be incremented. If the current software version can be incremented to be level with the upper-level version, the remote transmission systems accommodated by a network to which the transmission system belongs are tested for their versions. It is then judged that the acquired versions are interchangeable with the upper-level version on the network. If a version is interchangeable, the upper-level version is downloaded while the start of downloading is reported to the remote nodes. When downloading is completed, the end of downloading is reported.

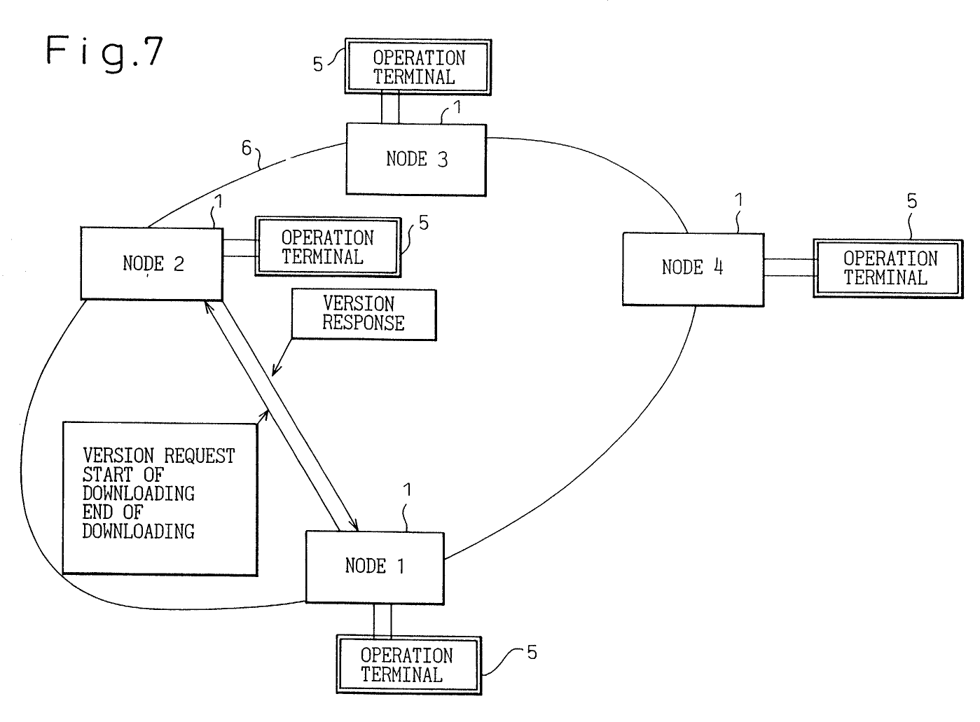

FIG. 7 shows an example of network architectures in which a transmission system of the present invention is employed. In FIG. 7, there are shown four transmission systems 1 (nodes), four operation terminals 5 associated with the transmission systems 1, and a transmission line 6. The operation terminals 5 (each corresponding to the downloading unit in FIG. 6) download software into the transmission systems.

Personal computers can be used as the operation terminals 5 in FIG. 7. The operation terminals 5 have a downloading facility and a facility for transferring signals to or from the remote nodes via the local transmission system 1. Any of transmission lines conformable to various transmission modes can be used as the transmission line 6. For example, a transmission line used to construct a communication network conformable a synchronous digital hierarchy (SDH) is used as the transmission line 6. Moreover, each transmission system 1 has software for realizing a transmission control facility for controlling transmission of signals in conformity with any transmission mode. When a transmission line conformable to the SDH is adopted, the transmission system includes an SDH communication control facility. An SDH frame employed in the SDH communication network is structured with a payload in which information transmitted to or from a user is specified, and overhead information used for monitoring or controlling a section or path for transmission.

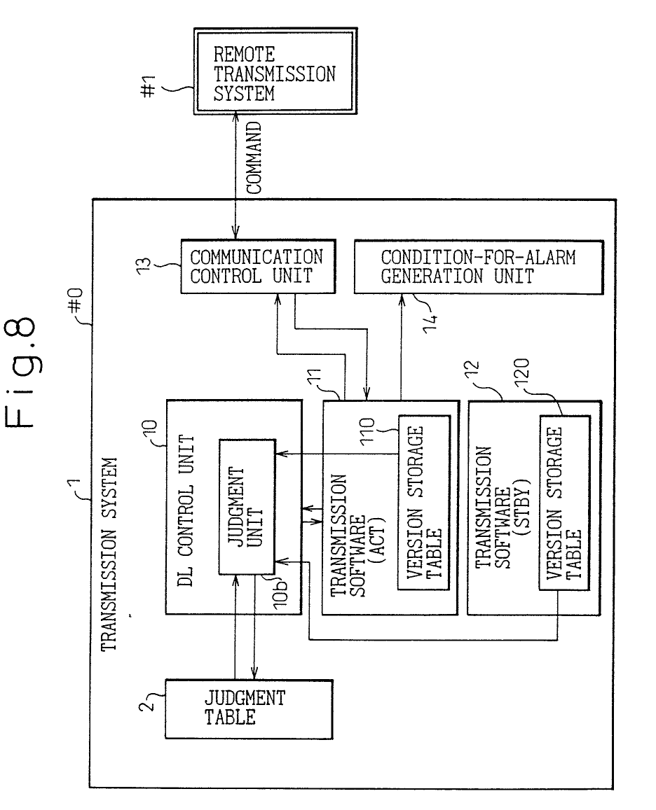

FIG. 8 shows the circuitry for the transmission system 1 (No. 0) to which the present invention is adapted. There are shown a downloading control unit 10 corresponding to the control unit in FIG. 6, a judgment unit 10b, active (currently used) and standby (auxiliary) transmission software 11 and 12, and transmission software version storage tables 110 and 120. Also shown are a communication control unit 13, a condition-for-alarm generation unit 14, and a judgment table 2.

Actions to be performed by the transmission system shown in FIG. 8 will be described briefly. The downloading control unit 10 acquires buffered software from the active and standby version storage tables 110 and 120. The downloading control unit 10 also acquires a software version existent in a remote transmission system via the (active) transmission software 11. Acquired information is specified in the judgment table 2. Based on the acquired information, the judgment unit 10b determines if downloading is enabled. If downloading is enabled, an alarm is generated. Thereafter, the software version is downloaded in the standby version storage table. The standby version storage table is switched to the active version storage table. Thereafter, the software version is downloaded in the active version storage table.

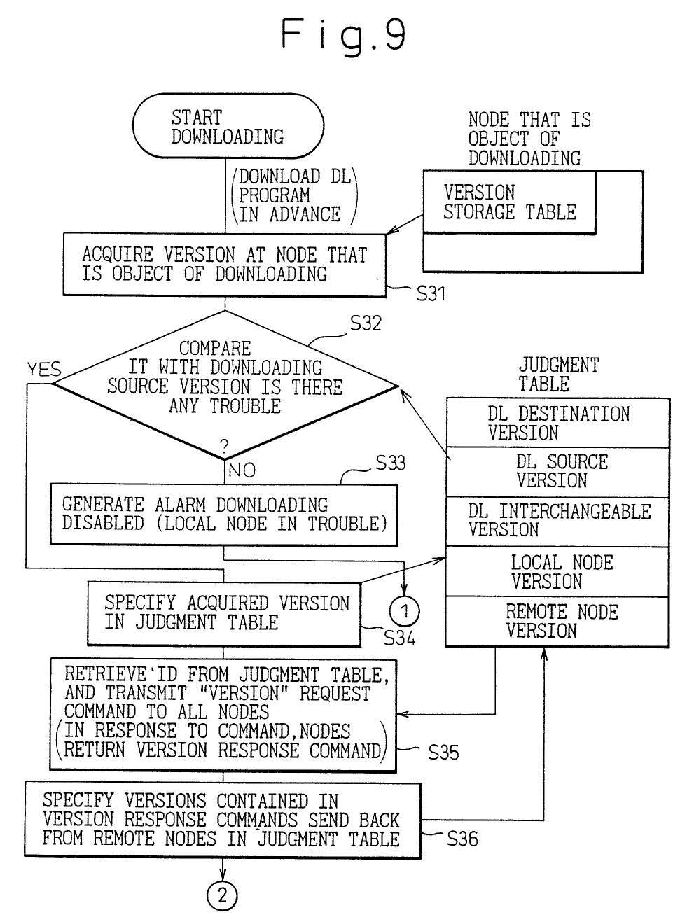

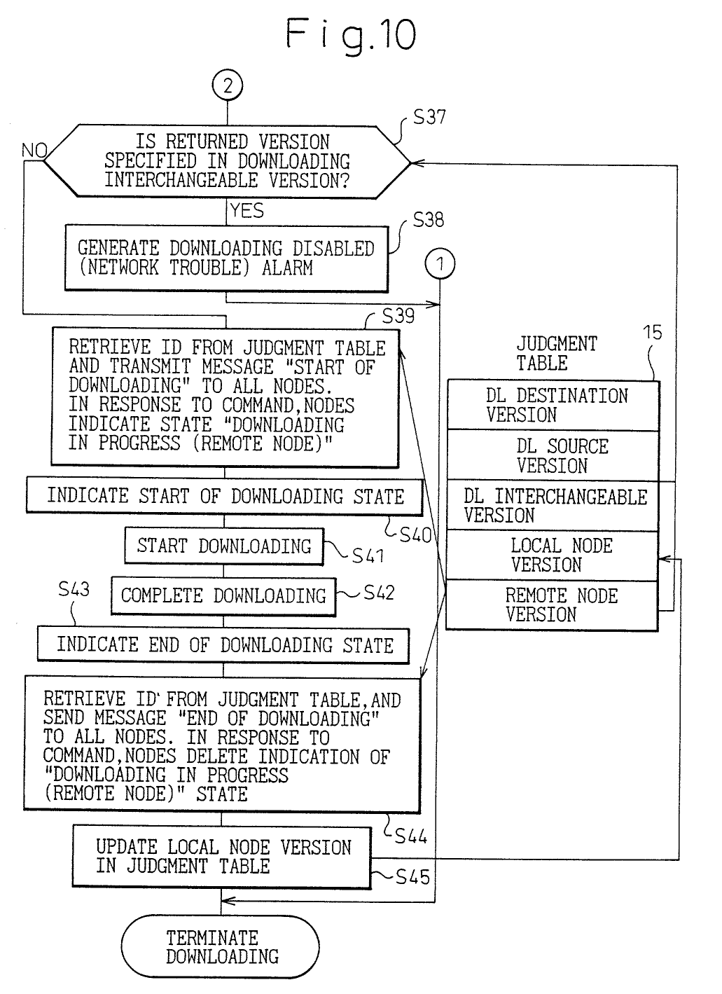

FIG. 9 and FIG. 10 are flowcharts part 1 and part 2 describing an example of downloading control. The processing sequence described in the flowcharts is carried out by the downloading (DL) control unit 10 in the transmission system shown in FIG. 8.

The contents of processing will be described below. A program for controlling downloading shall be downloaded to the downloading control unit 10 in advance. A version existing in a transmission system (node) that is an object of downloading is retrieved from a version storage table (110 or 120 in FIG. 8) in transmission software (11 or 12 in FIG. 8) (step S31). Meanwhile, a judgment table 2 is installed according to software to be downloaded. A downloading destination version, a downloading source version, a downloading interchangeable version, the identification number of a local node, and the identification numbers of all of remote nodes accommodated by the network are specified in the judgment table 2. As the downloading interchangeable version, versions usable (interchangeable with one another) on the network are specified.

The acquired software version existent in the transmission system (node) 1 is compared with the downloading source version specified in the judgment table 2 (step S32). If there is a trouble, that is, if the software version is not contained in the downloading source version, an alarm is generated in order to indicate that downloading is disabled (the local node is in trouble) (step S33). If there is no trouble, the acquired version is specified as the local node version in the judgement table (step S34). Thereafter, the identification numbers are retrieved from the judgment table, and a version request command is transmitted to all the nodes (step S35). In response to the command, the remote nodes send back a version response command, which contains a version existent in each remote node, to the node. The versions contained in the version response commands sent back from the remote nodes are specified in the item of the remote node version in the judgment table (step S36).

Thereafter, it is judged if a returned version existent at a remote node is contained in the downloading interchangeability version (version usable on the network) specified in the judgment table 2 (step S37). If it is found that the returned version is not contained in the downloading interchangeability version, an alarm indicating that downloading is disabled (network-related trouble) is generated (step S38). If it is found that the returned version is contained in the downloading interchangeability version, the node identification number is retrieved from the judgment table 2. A message (command) “Start of Downloading” is transmitted to all the nodes (step S39). In response to the message, a state “downloading in progress: node identification number (identification number of a node having transmitted Start of Downloading)” is indicated at the nodes. Thereafter, the state Start of Downloading is indicated at the local node (step S40). Downloading is started (step S41). When downloading is completed (step S42), an End of Downloading state is indicated at the local node (step S43). For downloading a version at the node, the standby transmission software 12 in FIG. 8 is overwritten with the version read from a recording medium that is not shown in FIG. 8. The recording medium is installed in a personal computer or the like connected to the node.

Thereafter, the identification number of the remote node is retrieved from the judgment table 2, and a message (command) “End of Downloading” is transmitted to all the nodes (step S44). In response to the command, the nodes delete the indication of the state “downloading in progress: node identification number (identification number of a node having transmitted End of Downloading).” Thereafter, the local node version specified in the judgment table 15 is updated to a new value (step S45). Downloading is terminated.

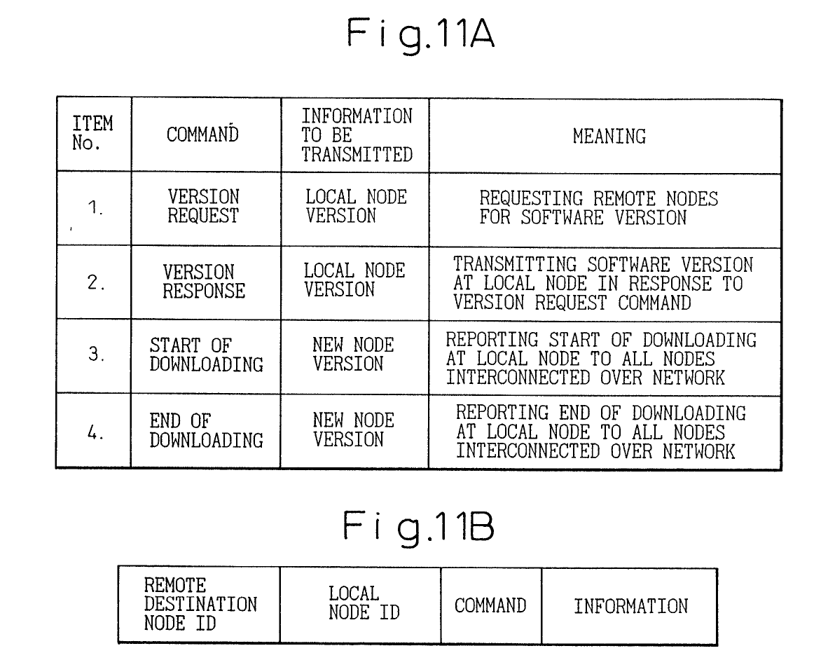

FIGS. 11A and 11B are explanatory diagrams concerning commands employed in the present invention. FIG. 11A lists the commands, and FIG. 11B shows the format of a command. In this example, as shown in FIG. 11A, four commands of items 1 to 4 are employed. The commands are structured according to the format shown in FIG. 11B. Each command is composed of a remote destination node, a local node, a command, and information. A version request command is intended to request a remote node for a software version. A version response command is intended to return a software version existent at the remote node. A command Start of Downloading and a command End of Downloading are intended to report the start and end of downloading performed at the local node to all the remote nodes interconnected over the network.

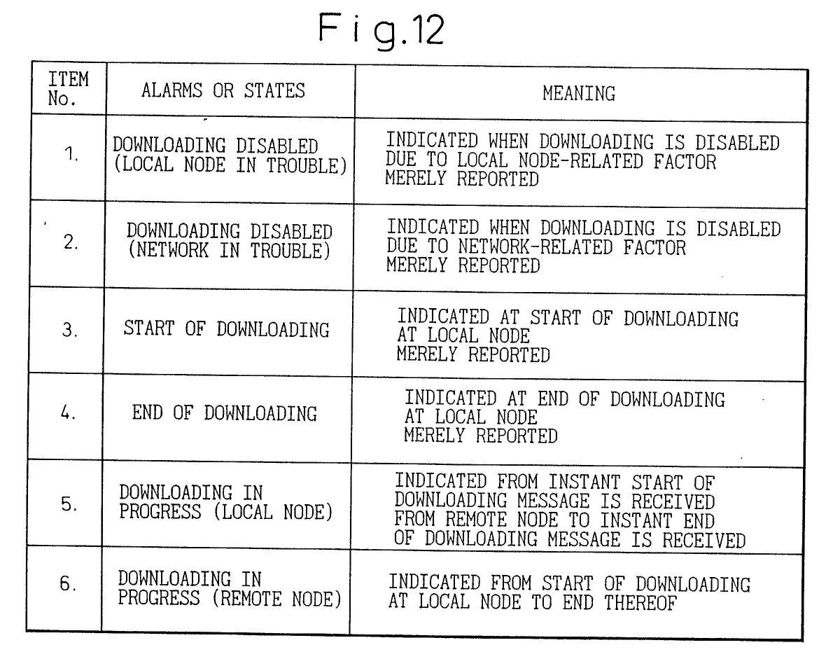

FIG. 12 lists the indications of alarms or states relevant to downloading and their meanings. The alarms or states are indicated at steps described in the flowcharts in accordance with the embodiment. FIG. 12 lists a total of six alarms or states of items 1 to 6.

The first items 1 and 2 specify the alarms “Downloading Disabled” occurring when the local node is in trouble and when the network is in trouble. The next items 3 and 4 specify the states “Start of Downloading” and “End of Downloading.” Moreover, the items 5 and 6 specify the states “Downloading in Progress (local node)” and “Downloading in Progress (remote node).” The indication of the former state means that the local node is engaged in downloading. The indication of the latter state means that a remote node is engaged in downloading from the instant it receives the message (command) Start of Downloading to the instant it receives the message (command) End of Downloading.

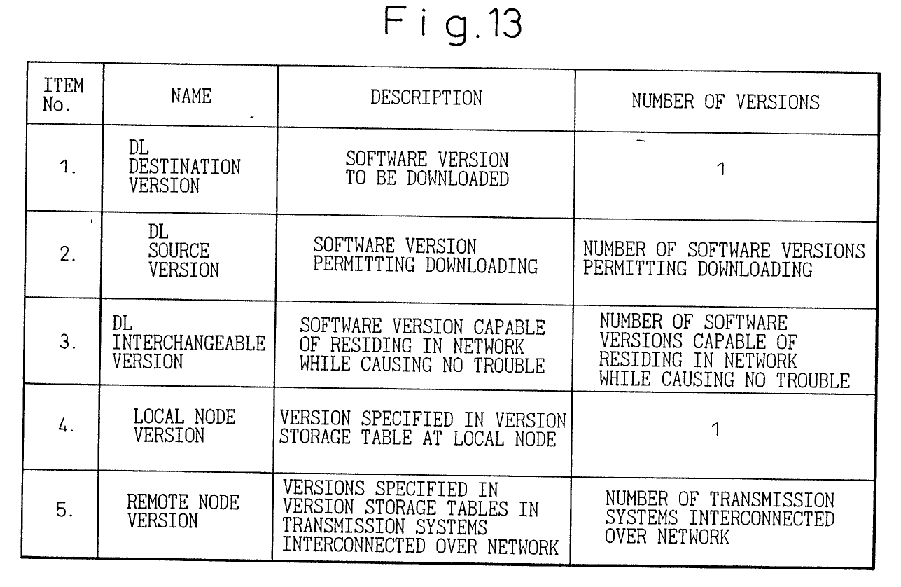

FIG. 13 is an explanatory diagram concerning a judgment table. The judgment table is, as described in conjunction with FIG. 6 and thereafter, used to check the compatibility of a version and manage versions. The size of the table is variable and the table is contained in the downloading program. The judgment table will be detailed below.

In the judgment table 2, one record is composed of three kinds of data; a node identification number, a version number, and a type. The node identification number uniquely identifies a transmission system connected on a network. The node identification number is employed in items “local node version” and “remote node version” in the judgment table. The version number means the number of a software version. The type means a type of version stored (downloading destination version, downloading source version, etc.). The type includes five types of types 1 to 5.

As shown in FIG. 13, when type 1 is specified as the type, the type of version is the downloading destination version indicating a software version to be downloaded. The downloading destination version numbers one. When type 2 is specified as the type, the type of version is the downloading source version indicating software versions existing in downloading sources and permitting downloading of the downloading destination version. A plurality of downloading source versions may be available. Moreover, when type 3 is specified as the type, the type of version is the downloading interchangeable version indicating software versions capable of residing in a network while causing no trouble. A plurality of downloading interchangeable versions may be available. When type 4 is specified as the type, the type of version is the local node version indicating a software version existent at a node into which a version is downloaded. The local node version numbers one. Furthermore, when type 5 is specified as the type, the type of version is the remote node version indicating software versions specified in the version storage tables in transmission systems (nodes) interconnected over the network. The number of remote node versions corresponds to the number of remote transmission systems interconnected over the network.

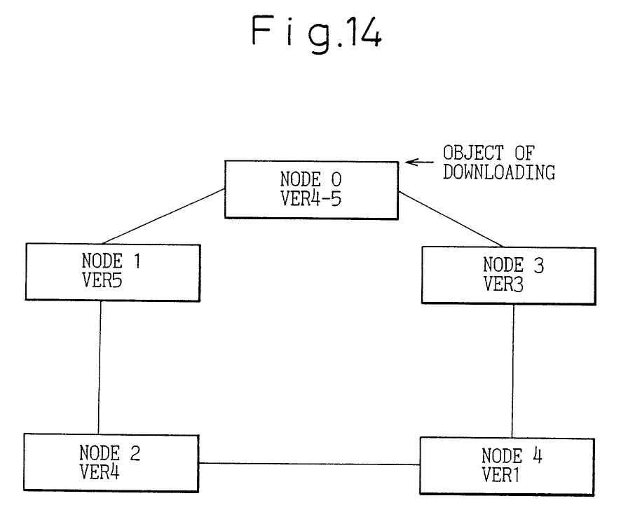

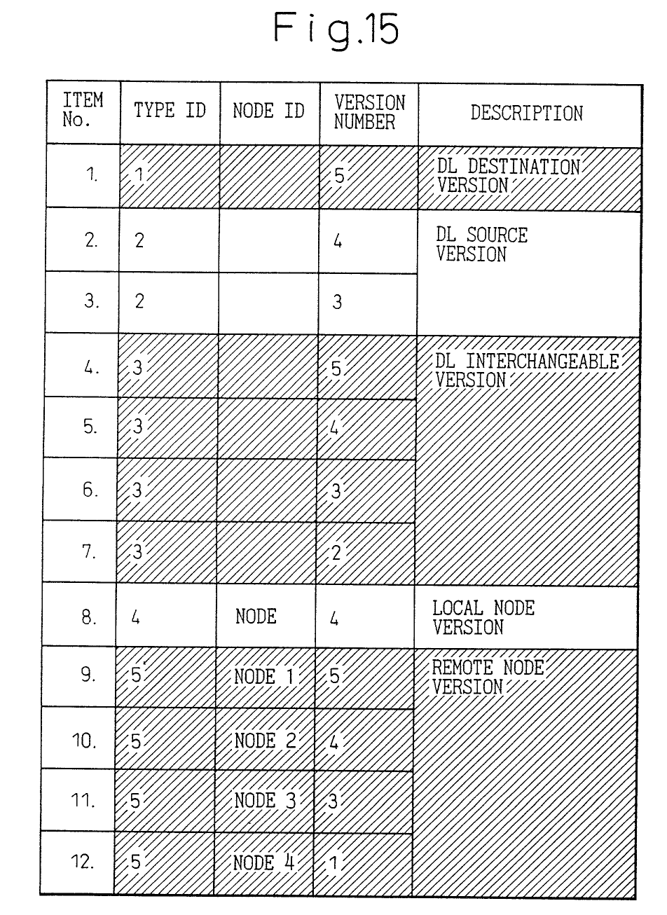

Next, an example of downloading will be described. FIG. 14 shows the architecture of a network referred to in the description of the example. FIG. 15 shows the contents of the judgment table. Referring to FIG. 14, five transmission systems are accommodated by a network. The node identification numbers of the transmission systems are node 0, node 1, node 2, node 3, and node 4. In the network having this architecture, the version number of software existent at the node of node 0 is 4. Assuming that software of a version number 5 is downloaded into the node of node 0, a judgment table shown in FIG. 15 is employed.

The judgment table shown in FIG. 15 has items 1 to 12. A version of type 1 (downloading destination version) has a version number 5, and versions of type 2 (downloading source version) have version numbers 3 and 4. This means that if a downloading source version has the version number 3 or 4, a version 5 can be downloaded. Moreover, interchangeable versions of type 3 that can reside in the network shown in FIG. 14 are specified in items 4 to 7 in FIG. 15. Versions of version numbers 5, 4, 3, and 2 are the interchangeable versions. Moreover, a local node version of type 4 has a version number 4 according to the flowchart of FIG. 9. The version numbers of versions of type 5 existing at remote nodes are used to transmit a version request command to the remote nodes according to the present invention. The version numbers of versions of type 5 existent at the remote nodes are returned from the nodes in response to the version request. In FIG. 15, version numbers 5, 4, 3, and 1 are specified in items 9 to 12 in association with node 1, node 2, node 3, and node 4.

In this example of judgment tables, the version number of a version existent at node 4 that is one of the remote nodes is 1. According to the flowchart describing downloading in an embodiment of the present invention, since the version numbers of the interchangeable versions on the network are 2 to 5, the version number 1 is not included in those of the interchangeable versions. The version of the version number 5 will therefore not be downloaded into node 0.

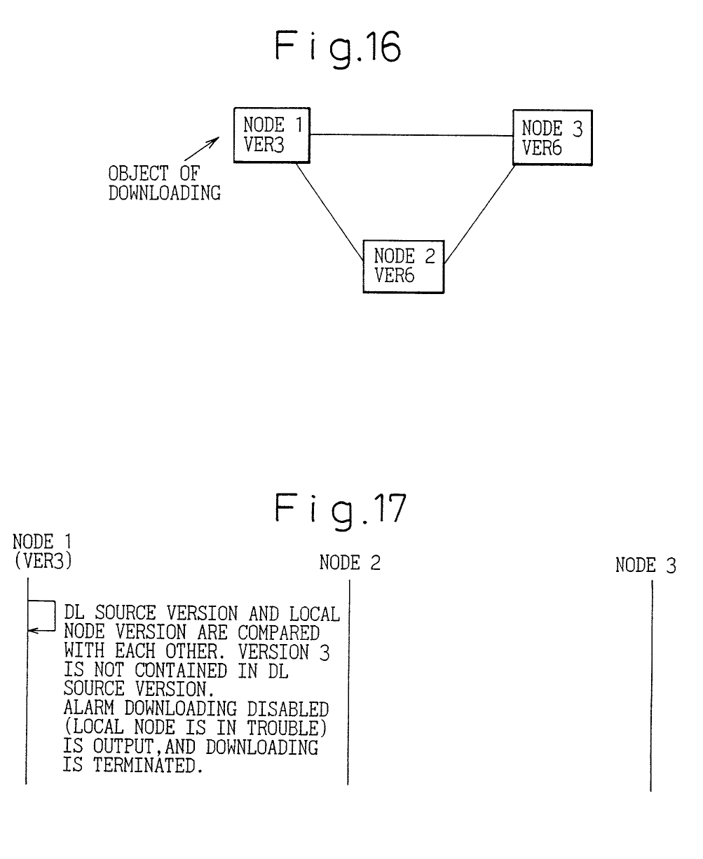

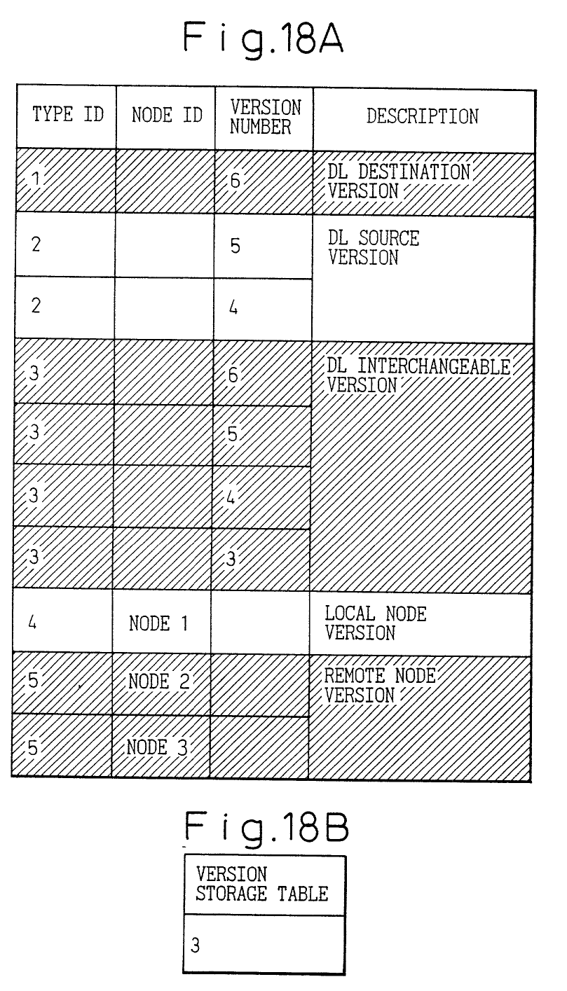

FIG. 16 to FIG. 18B relate to the first example of downloading control. FIG. 16 shows the architecture of a network in which the first example is implemented. FIG. 17 shows a processing sequence. FIG. 18A shows a judgment table relevant to the first example, and FIG. 18B shows a version storage table.

The first example is concerned with a network composed of, as shown in FIG. 16, node 1, node 2, and node 3. The first example is such that a version of a version number 6 is downloaded into node 1. In this architecture, node 1 first retrieves a version number 3 from the local node version storage table (FIG. 18B). The retrieved local node version number 3 is, as shown in FIG. 17, compared with the downloading source version. At this time, version numbers 5 and 4 are specified as the downloading source version in the judgment table shown in FIG. 18A. It is seen that the version number 3 of a version existent at the local node is not contained in the downloading source version. In this example, an alarm Downloading Disabled (disabled because the local node is in trouble) is output and downloading is terminated. In this example, a version request is not issued to the remote nodes.

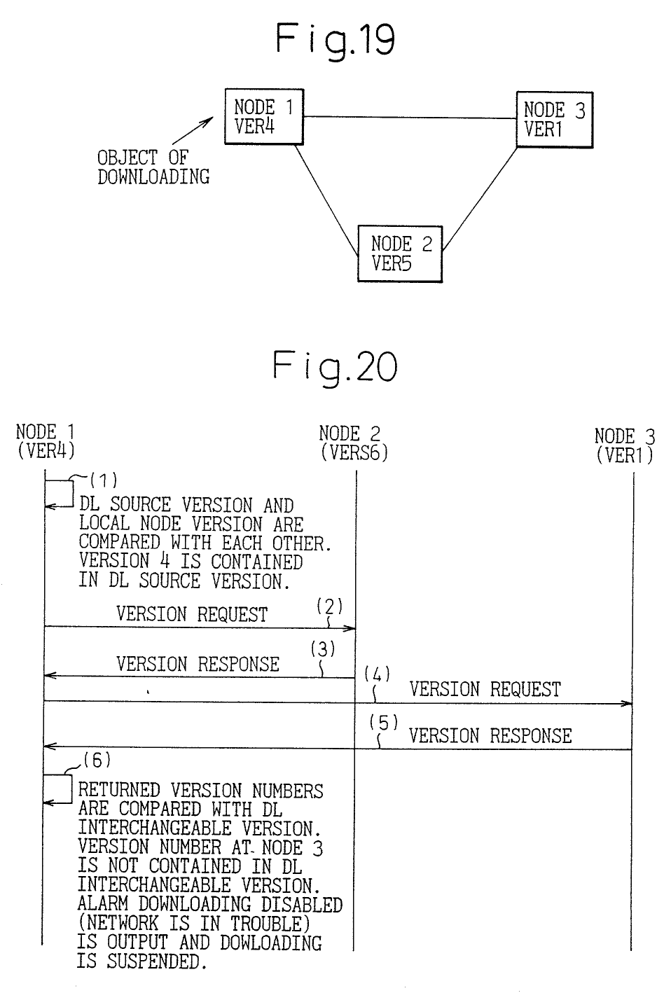

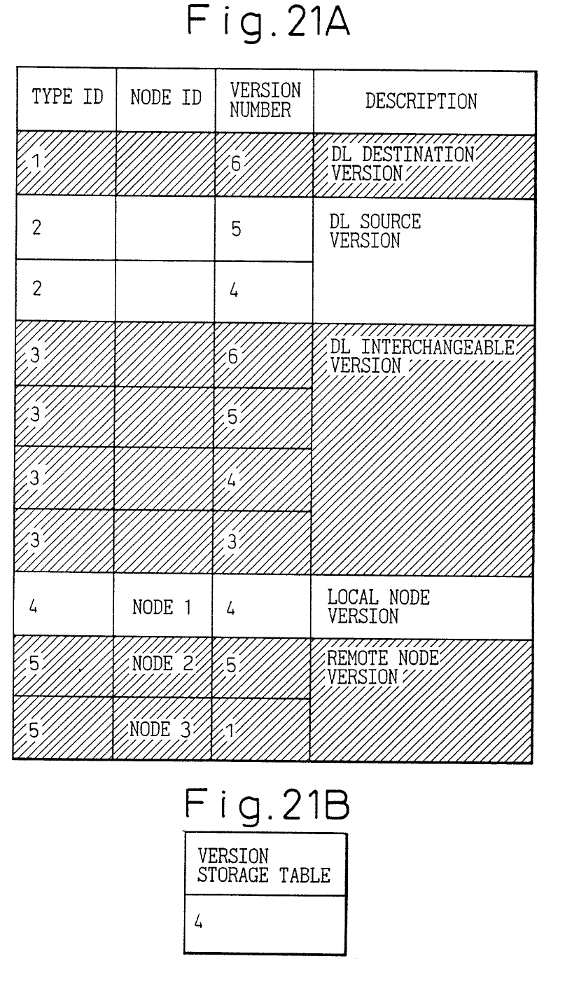

FIG. 19 to FIG. 21B relate to the second example of downloading control according to which downloading cannot be carried out. FIG. 19 shows the architecture of a network that is an object of downloading control. FIG. 20 shows a sequence of actions. FIG. 21A shows a judgment table relevant to the second example, and FIG. 21b shows a version storage table.

In the second example, the network is composed of node 1, node 2, and node 3. A version of a version number 6 is to be downloaded into node 1. In this architecture, node 1 retrieves a version number 4 from the local node version storage table (FIG. 21B).

Next, the retrieved version number 4 of the version existent at the local node is compared with the downloading source version as described as action (1) in FIG. 20. At this time, version numbers 5 and 4 are specified as the downloading source version in the judgment table shown in FIG. 21A. It is seen from the judgment table that since the local node version number 4 is contained in the downloading source version. As described as actions (2) and (4) in FIG. 20, a version request command is transmitted to the remote nodes (node 2 and node 3). As described as actions (3) and (5), responses of versions are received from the remote nodes. In the second example, a version number 5 is returned from node 2, and a version number 1 is returned from node 3. The version numbers 5 and 1 are, as shown in FIG. 21A, specified in items of type 5 associated with node 2 and node 3. As described as action (6) in FIG. 20, the received version numbers of the versions existent at node 2 and node 3 are compared with the downloading interchangeable version for the network specified in the judgment table. It is seen that the version number 1 of the version existent at node 3 is not contained in the downloading interchangeable version. Downloading Disabled (because the network is in trouble) is then generated and downloading is suspended.

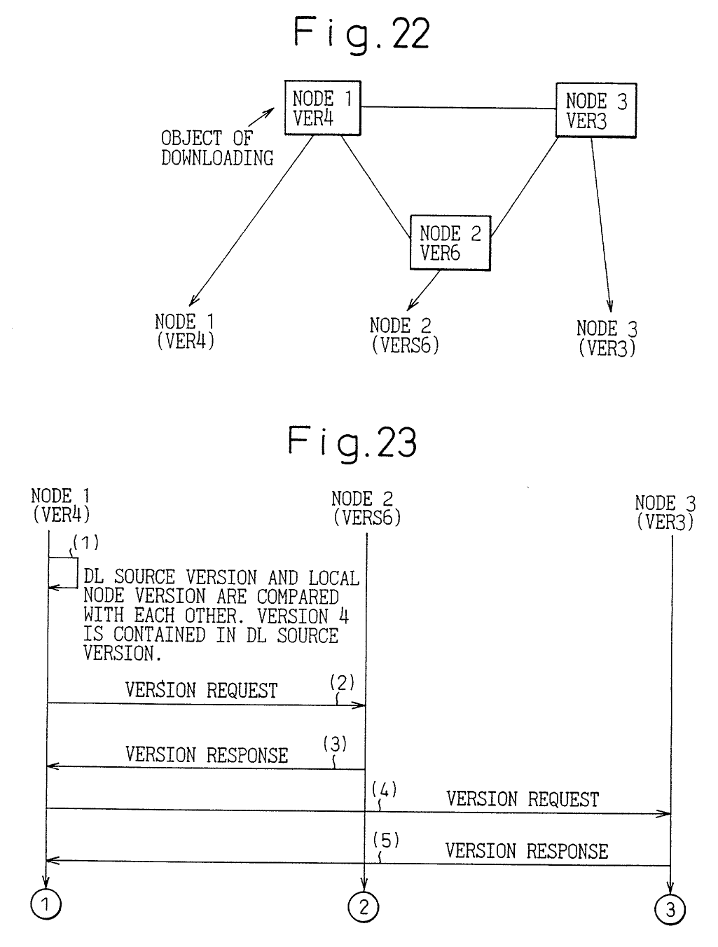

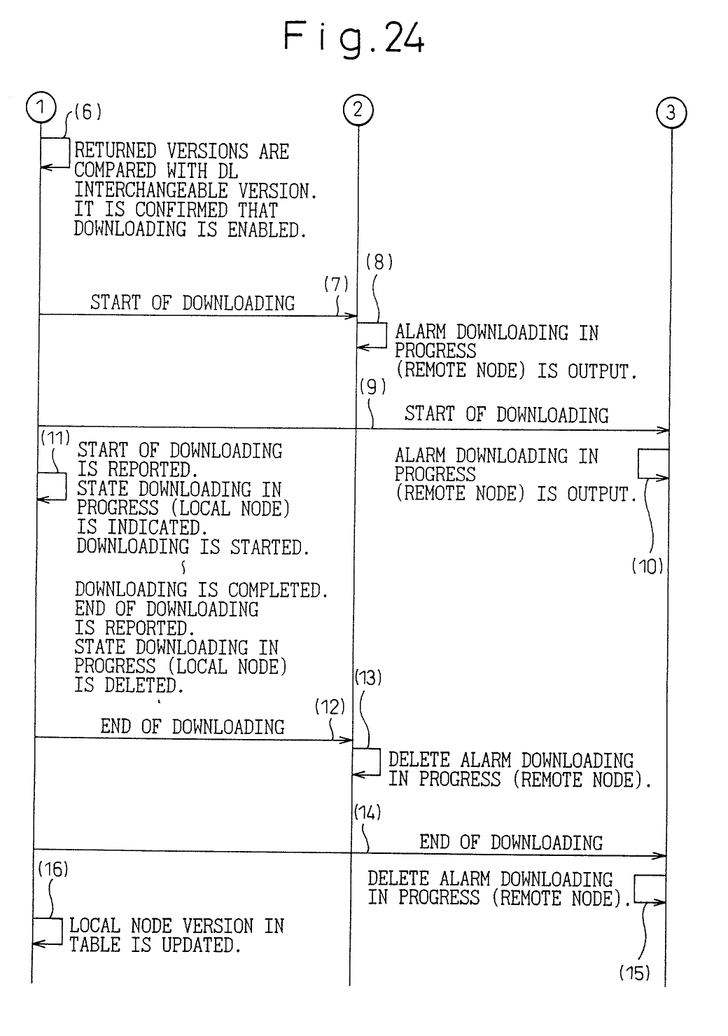

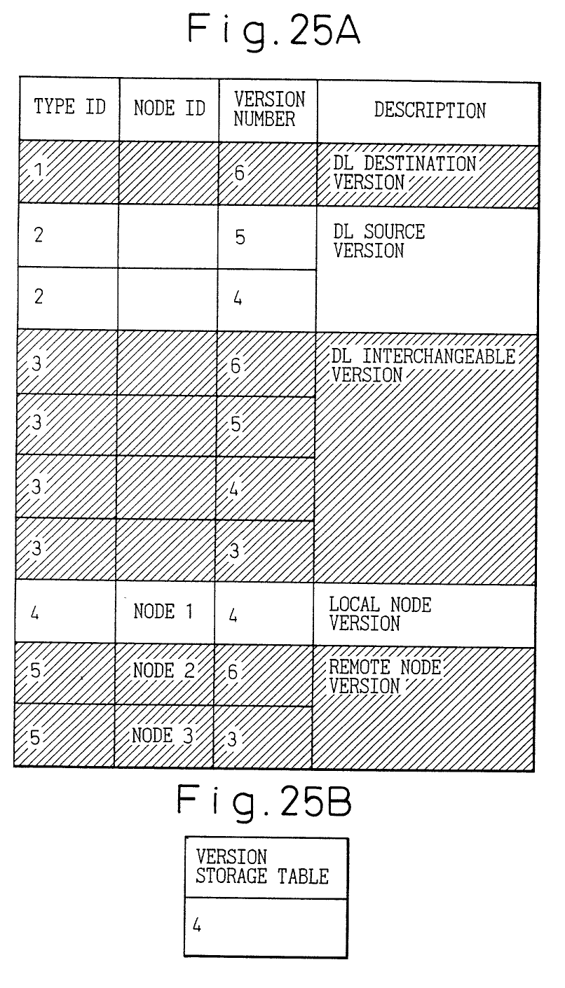

FIG. 22 to FIG. 25B relate to the third example of downloading control according to which downloading is enabled. FIG. 22 shows the architecture of a network in which the third example is implemented. FIG. 23 and FIG. 24 describe a sequence of actions for downloading control of the third example. FIG. 25A shows a judgment table employed in the third example, and FIG. 25B shows a version storage table.

The third embodiment is implemented in a network having the architecture shown in FIG. 22. The network is composed of node 1 to node 3. Current software versions existent at the nodes have version numbers 4, 6, and 3. In this case, software of version 6 is to be downloaded into node 1.

In this architecture, node 1 retrieves a version number 4 from the local node version storage table (FIG. 25B).

Thereafter, the retrieved version number 4 of a version existent at the local node is compared with the downloading source version as described as action (1) in FIG. 23. At this time, the downloading source version permitting downloading of version 6 specifies versions 5 and 4 in the judgment table shown in FIG. 25A. It is seen that the version number 4 of the version existent at the local node is contained in the downloading source version. As described as actions (2) and (4) in FIG. 23, a version request command is transmitted to the remote nodes (node 2 and node 3). As described as actions (3) and (5), responses of version numbers are received from the remote nodes. In the third example, a version number 6 is received from node 2 and a version number 3 is received from node 3. The version numbers are specified in items of type 5 associated with node 2 and node 3 in the judgment table shown in FIG. 25A. Thereafter, as described as action (6) in FIG. 24, the version numbers of the versions existing at node 2 and node 3 are compared with the downloading interchangeable version for a network specified in association with type 3 in the judgment table shown in FIG. 25A. In this example, the downloading interchangeable version specifies version numbers 3, 4, 5, and 6. It is seen that the version numbers of the versions existent at node 2 and node 3 are contained in the downloading interchangeable version. As described as actions (7) and (9) in FIG. 24, the command Start of Downloading is reported to node 2 and node 3 that are the remote nodes. Node 2 and node 3 that are the remote nodes output, as described as actions (8) and (10), an alarm indicating that a remote node (that is node 1) is engaged in downloading.

At node 1, as described as action (11) in FIG. 24, Start of Downloading is reported to the downloading control unit at the local node. The state Downloading in Progress at Local Node is indicated and downloading is started. When downloading is completed, End of Downloading is reported. The indication of the state Downloading in Progress at Local Node is deleted. Successively, as described as actions (12) and (14) in FIG. 24, the command End of Downloading is transmitted to node 2 and node 3 that are the remote nodes. In response to the command, node 2 and node 3 delete the indication of the alarm Downloading in Progress. At node 1, the version number in the local node version storage table (FIG. 25B) is updated from 3 to 6. Moreover, the version number associated with type 3 of the local node version in the judgment table is updated into 6.

According to the present invention, the condition for a version at a downloading source that permits downloading is defined in advance. When the condition is met, whether downloading is enabled is determined by checking all versions existent at transmission systems constituting a network. A trouble stemming from downloading can therefore be prevented.

Moreover, a difference in version number is indicated as an alarm at all the transmission systems. It can therefore be prevented that the operators of the transmission systems incorrectly operate the transmission systems.

Furthermore, a special server is unnecessary. Downloading can be carried out in consideration of versions acceptable by the network. If a failure occurs on the network, it may become impossible to communicate with a server. Nevertheless, downloading can be carried out.

What is claimed is:

1. A method of downloading software of a new version into a control unit in a transmission system connected on a network, comprising the steps of:
when said new software is run in said transmission system, specifying an interchangeable version, which indicates software versions capable of residing in said network, in a judgment table;
transmitting a command for requesting version information of current software existing in a transmission system to remote transmission systems interconnected over said network;
receiving version information from said remote transmission systems;
judging whether version information received from said remote transmission systems is contained in said interchangeable version;
when it is judged that version information is contained in said interchangeable version, sending a command, which indicates that said local transmission system should start downloading, to said remote transmission systems;
downloading said software of a new version; and
after downloading is completed, reporting the end of downloading to said remote transmission systems.

2. A downloading method according to claim 1, wherein said received version information is specified in said judgment table.

3. A downloading method according to claim 1, wherein at said judging step, when it is judged that said version information received from said remote transmission systems is not contained in said interchangeable version, an alarm is generated and downloading is suspended.

4. A method of downloading software of a new version into a control unit in a transmission system connected on a network, comprising the steps of:
when said new software is run in said transmission system, specifying an interchangeable version, which indicates software versions capable of existing on said network, in a judgment table;
specifying downloading source version information, which indicates software versions permitting said software of a new version to be treated as an object of downloading, in said judgment table;
judging if a software version existent at a local transmission system is contained in said downloading source version information;
when it is judged at said judging step that said version existent at said local node is contained in said downloading source version information, transmitting a command for requesting version information of current software existing in a transmission system to remote transmission systems interconnected over said network;
receiving version information from said remote transmission systems;
judging if version information received from said remote transmission systems is contained in said interchangeable version;
when said version information is contained in said interchangeable version, sending a command, which indicates that said local transmission system should start downloading, to said remote transmission systems;
downloading said software of a new version; and
after downloading is completed, reporting the end of downloading to said remote transmission systems.

5. A downloading method according to claim 4, wherein said software version existing in said local node is specified in advance in a version storage table.

6. A downloading method according to claim 4, wherein said received version information is specified in said judgment table.

7. A downloading method according to claim 4 wherein, when it is judged at said judging step that said software version existing in said local node is not contained in said downloading source version information, or that said version information received from said remote transmission systems is not contained in said interchangeable version, an alarm is generated and downloading is suspended.

8. A transmission system connected to a network for controlling downloading of software of a new version, comprising:
a communication unit for communicating control information to remote transmission systems interconnected over said network;
a judgment table for specifying an interchangeable version that indicates software versions capable of residing in said network with said new software run in said transmission system;
a judgment unit for judging from software version information received from said remote transmission systems and said interchangeable version if downloading is enabled; and
a control unit for, at the time of downloading, if said communication unit receives version information from remote transmission systems and said judgment unit judges that the versions are compatible with said transmission system, executing downloading of said new software.

9. A transmission system according to claim 8, wherein when said communication unit receives version information from remote transmission systems, said control unit specifies the received version information in said judgment table.

10. A transmission system according to claim 8, wherein if said judgment unit judges that downloading is disabled, said control unit generates an alarm and suspends downloading.

11. A transmission system connected to a network for controlling downloading of software of a new version, comprising:
a communication unit for communicating control information to remote transmission systems interconnected over said network;
a version storage table for specifying a software version existent in a local transmission system;
a judgment table for specifying downloading source version information that indicate software versions permitting said software of a new version to be treated as an object of downloading, and also specifying an interchangeable version that indicates software versions capable of residing in said network with said new software run in said transmission system;
a judgment unit for judging from said software version information received from said remote transmission systems and said interchangeable version as well as said version of software existent at said local transmission system and said downloading source version information if downloading is enabled; and
a control unit for, at the time of downloading, if said communication unit receives version information from remote transmission systems and said judgment unit judges that downloading is enabled, downloading said new software.

12. A transmission system according to claim 11 wherein, when said communication unit receives version information from remote transmission systems, said control unit specifies the received version information in said judgment table.

13. A transmission system according to claim 11 wherein, when said judgment unit judges that downloading is disabled, said control unit generates an alarm and suspends downloading.
